(19) United States
(12) Patent Application Publication
(10) Pub. No.: US 2016/0343400 A1
(43) Pub. Date: Nov. 24, 2016

(54) MAGNETIC DISK DEVICE, CONTROLLER, AND REDUNDANT SECTOR ARRANGEMENT METHOD

(71) Applicant: Kabushiki Kaisha Toshiba, Tokyo (JP)

(72) Inventors: Shuuichi Kojima, Tokyo (JP); Masahide Kanegae, Fujisawa Kanagawa (JP)

(21) Appl. No.: 14/835,320

(22) Filed: Aug. 25, 2015

(30) Foreign Application Priority Data
May 19, 2015 (JP) 2015-101947

(51) Int. Cl. G11B 20/18

(52) U.S. Cl. CPC G11B 20/1889

(57) ABSTRACT

According to one embodiment, a magnetic disk device includes a disk and a controller. The disk includes a storage area having a plurality of tracks. The controller groups, data sector by data sector into a plurality of groups forming a first set of groups, a plurality of data sectors arranged on each of the plurality of tracks, such that those of the plurality of groups that are arranged at least adjacent to each other differ in position from each other. Further, the controller arranges a plurality of redundant sectors corresponding to the plurality of groups in a free area in the storage area.

### CROSS-REFERENCE TO RELATED APPLICATIONS

This application is based upon and claims the benefit of priority from Japanese Patent Application No. 2015-101947, filed May 19, 2015, the entire contents of which are incorporated herein by reference.

### FIELD

Embodiments described herein relate generally to a magnetic disk device, a controller, and a redundant sector arrangement method.

### BACKGROUND

In a magnetic disk device, data is written to and read from a disk block by block (the block has a given size and is called a sector). A magnetic disk device of this type generally has a mechanism for restoring data of a sector (that is, an error sector) when an error is detected during a read from the sector. A method (redundant sector arrangement method) of allocating redundant sectors to respective sets of sectors (hereinafter, referred to as sector groups) is known as a type of the above-mentioned mechanism.

In a magnetic disk device that employs the method, for example, data of a first redundant sector corresponding to a first group is obtained by performing an exclusive-OR (XOR) operation on data of all sectors of the first group bit by bit. If one of the sectors in the first group is detected as an error sector, the data of the error sector is recovered by performing an XOR operation bit by bit on the data of all sectors of the first group except the error sector, and the data of the first redundant sector.

However, if at least two sectors in the first group are detected as error sectors, it is difficult to recover the data of the at least two sectors. This situation will occur when, for example, a disk flaws over the at least two sectors.

### BRIEF DESCRIPTION OF THE DRAWINGS

FIG. 1 is a block diagram showing an exemplary configuration of a magnetic disk device according to an embodiment;

FIG. 2 is a view showing an example of a first set of groups included in a band on the disk shown in FIG. 1;

FIG. 3 is a view showing an example of a second set of groups in the band in a case where the band has the second set of groups in addition to the first set of groups;

FIG. 4 is a view showing examples of the first set of groups and defective sectors in a case where the band has only the first set of groups;

FIG. 5 is a view showing examples of the first and second sets of groups and defective sectors in a case where the band has the second set of groups in addition to the first set of groups;

FIG. 6 is a view showing examples of the first and second sets of groups and defective sectors in a case where the number of defective sectors is greater by one than in the case of FIG. 5;

FIG. 7 is a view directed to a case where the band has a third set of groups in addition to the first and second sets of groups, and showing examples of the first to third sets of groups and defective sectors therein;

FIG. 8 is a block diagram showing an exemplary configuration of an HDD, shown in FIG. 1, related to an exclusive OR (XOR) operation;

FIG. 9 is a flowchart showing an exemplary procedure of write processing in the embodiment;

FIG. 10 is a view for explaining an example of XOR data processing performed at a first time point of the write processing;

FIG. 11 is a view for explaining an example of XOR data processing performed at a second time point of the write processing;

FIG. 12 is a view for explaining an example of XOR data processing performed at a third time point of the write processing;

FIG. 13 is a view for explaining an example of XOR data processing performed at a fourth time point of the write processing; and

FIG. 14 is a flowchart showing an exemplary procedure of XOR-data load processing in the embodiment.

### DETAILED DESCRIPTION

Various embodiments will be described hereinafter with reference to the accompanying drawings.

In general, according to one embodiment, a magnetic disk device includes a disk and a controller. The disk includes a storage area having a plurality of tracks. The controller groups, data sector by data sector into a plurality of groups forming a first set of groups, a plurality of data sectors arranged on each of the plurality of tracks, such that those of the plurality of groups that are arranged at least adjacent to each other differ in position from each other. Further, the controller arranges a plurality of redundant sectors corresponding to the plurality of groups in a free area in the storage area.

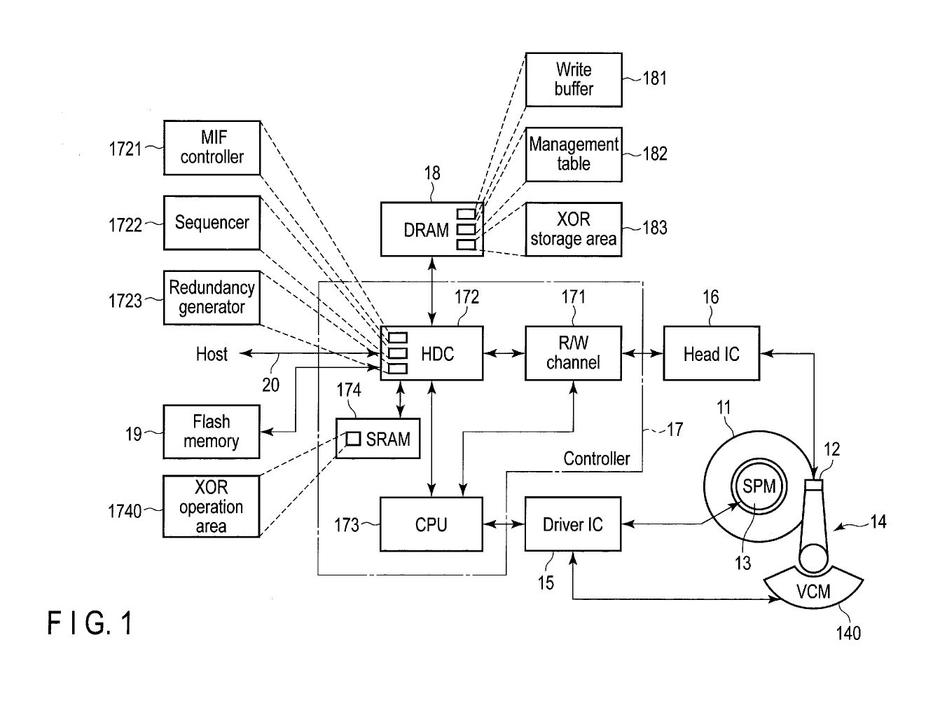

FIG. 1 is a block diagram showing an exemplary configuration of a magnetic disk device according to an embodiment. The magnetic disk device is also called a hard disk drive (HDD). In the description below, the magnetic disk device will be referred to as the HDD. The HDD shown in FIG. 1 includes a disk (magnetic disk) 11, a head (magnetic head) 12, a spindle motor (SPM) 13, an actuator 14, a driver head IC 15, a head IC 16, a controller 17, a dynamic RAM (DRAM) 18 and a flash memory 19.

The HDD shown in FIG. 1 is, for example, a singled magnetic recording (SMR) drive or an Internet protocol (IP) drive. The SMR and IP drives are known as HDDs that employ an addressing scheme where physical positions (for example, sector positions) on the disk 11 are dynamically allocated to logical addresses (for example, logical block addresses). However, the HDD shown in FIG. 1 is not limited to the SMR or IP drive.

The disk 11 is a magnetic recording medium having, for example, one surface that serves as a recording surface on which data is magnetically recorded. The disk 11 is rotated at high speed by the SPM 13. The SPM 13 is driven by a drive current (voltage) supplied from (applied by) the driver IC 15. The disk 11 (more specifically, the recording surface of the disk 11) is divided into, for example, a plurality of concentric storage areas. Namely, the disk 11 includes a plurality of concentric storage areas. It is assumed that the number of the storage areas is n. Each of n storage areas is generally called a band (or a band area), and includes a plurality of tracks. Each band is used as, for example, a write once type access area. Namely, in the embodiment, data is rewritten band by band on the disk 11. Further, in the embodiment, data is erased band by band.

The head 12 is disposed in association with the recording surface of the disk 11. The head 12 includes a read element used to read data from the disk 11, and a write element used to write data to the disk 11. The read and write elements are also called a reader and a writer, respectively. It is assumed that the write element has a greater width than the read element. In the embodiment, singled magnetic recording is utilized for writing data to a band on the disk 11. In the shingled magnetic recording, data is sequentially written from a leading track to a last track in a band. Whenever data corresponding to one track is written to a band, the write element (head 12) is moved radially on the disk 11 only by a pitch corresponding to a path (read track) that the read element traces.

The head 12 is attached to the tip of the actuator 14. When the disk 11 rotates at high speed, the head 12 floats above the disk 11. The actuator 14 includes a voice coil motor (VCM) 140 used as a drive source for the actuator 14. The VCM 140 is driven by a drive current (voltage) supplied from (applied by) the driver IC 15. When the actuator 14 is driven by the VCM 140, the head 12 moves over the disk 11 in the radial direction of the disk 11 so as to draw an arc.

Unlike the configuration of FIG. 1, the HDD may include a plurality of disks. Further, the disk 11 shown in FIG. 1 may have recording surfaces on the both sides thereof, and heads may be disposed in association with the respective recording surfaces.

The driver IC 15 drives the SPM 13 and the VCM 140 under control of the controller 17 (more specifically, a CPU 173 in the controller 17). The head IC 16 includes a read amplifier and amplifies a signal (that is, a read signal) read by the head 12. The head IC 16 also includes a write driver, and converts, into a write current, write data sent from an R/W channel 171 in the controller 17, thereby sending the write current to the head 12.

The controller 17 is realized by, for example, a large-scale integrated circuit (LSI) called a system-on-a-chip (SOC) in which a plurality of elements are integrated on a single chip. The controller 17 includes a read/write (R/W) channel 171, a hard disk controller (HDC) 172, the CPU 173 and a static RAM (SRAM) 174.

The R/W channel 171 processes signals associated with reading and writing. The R/W channel 171 digitizes a read signal, using an analog-to-digital converter, and decodes the resultant digital data into read data. Further, the R/W channel 171 extracts, from the digital data, servo data needed for positioning the head 12. The R/W channel 171 encodes write data.

The HDC 172 is connected to a host (host device) via a host interface 20. The HDC 172 receives user commands (a write command, a read command, etc.) from the host. The HDC 172 controls data transfer between the host and the DRAM 18 and between the DRAM 18 and the R/W channel 171.

The HDC 172 includes a memory interface (MIF) controller 1721, a sequencer 1722 and a redundancy generator 1723. The MIF controller 1721 controls access to the DRAM 18, the flash memory 19 and the SRAM 174. The sequencer 1722 controls operations including generation of redundant data by the redundancy generator 1723, and writing of the generated redundant data to the disk 11, the DRAM 18 and the SRAM 174.

The redundancy generator 1723 generates redundant data, such as exclusive OR (XOR) data. In the embodiment, a set of sectors in each band is divided into a plurality of groups in accordance with a grouping rule. The entire groups are collectively referred to as a set of groups. The XOR data is generated group by group. Accordingly, each group is regarded as an XOR (XOR operation) group (redundancy group).

Assume here that an i^{th} band (i=0, 1, . . . , n−1) on the disk 11 is referred to as band BNDi, and a certain group in band BNDi is referred to as group j. Further, XOR data corresponding to group j is referred to as data XOR_j. The redundancy generator 1723 generates XOR data XOR_j by sequentially performing an XOR operation bit by bit on data (user data) of all sectors included in band BNDi and in group j. XOR data XOR_j is set (stored) in a redundant sector corresponding to group j. That is, a redundant sector (hereinafter, referred to as an XOR sector) includes XOR data. In the description below, a sector (namely, a sector for storing user data) in each group may be referred to as a data sector.

The CPU 173 functions as a main controller in the HDD shown in FIG. 1. In accordance with a control program, the CPU 173 controls at least part of elements in the HDD, which includes the HDC 172. In the embodiment, the control program is pre-stored in a specific area of the disk 11. However, the control program may be pre-stored in the flash memory 19.

The SRAM 174 is a volatile memory that operates at higher speed than the DRAM 18. In the embodiment, the storage capacity of the SRAM 174 is smaller than that of the DRAM 18. Part of the storage area of the SRAM 174 is allocated to an XOR operation area 1740. The XOR operation area 1740 is used for storing XOR data used for the XOR operation.

The DRAM 18 is used for temporarily storing write data transmitted from the host and read data read from the disk 11. A part of the storage area of the DRAM 18 is allocated to a write buffer 181. Another part of the storage areas of the DRAM 18 is used for storing a management table 182. Yet another part of the storage area of the DRAM 18 is used as an XOR storage area 183 for storing XOR data (more specifically, a newest halfway result during an XOR operation) in each group of a band in which data is currently being additionally written.

The management table 182 is used for managing correspondence in each band between logical addresses (for example, logical block addresses) and physical addresses, sector by sector, in association with sectors where data is written (additionally written). Suppose here that data corresponding to a certain block address (LBA) is newly written to a band. In this case, in the embodiment, the data is not overwritten to a band corresponding to the LBA. That is, data is written to a free band. During the write to the band, a flag set in an entry of the management table 182 associated with the band indicates that data is now being written. Therefore, the sequencer 1722 (or the CPU 173), for example, can specify which band is now being written, referring to the flag. When the write to the band has been completed, the sequencer 1722 updates, in the management table 182, data indicating the correspondence between the LBA and the physical address.

The management table 182 also holds, band by band, data indicating the grouping rule. The grouping rule includes a set of groups, an order of groups and a shift in group position. The order of groups refers to an order in which sectors in each track of a band are grouped into a plurality of groups that form a set of groups. That is, the order of groups also refers to the arrangement order of the groups. The group position refers to each of the positions of a plurality of groups in each track of a band. In other words, the group position is shifted by a given number of sectors (for example, one sector) track by track, based on the order of groups. The shift in group position refers to this shift.

Further, the data indicating the grouping rule includes a group order parameter and a shift parameter. The group order parameter indicates the order of groups (the arrangement order of the groups) and a set of groups. The shift parameter indicates the shift (group position shift). The data indicating the grouping rule may be shared among all bands on the disk 11.

The flash memory 19 is a rewritable nonvolatile memory. Part of the storage area of the flash memory 19 pre-stores an initial program loader (IPL). The CPU 173 loads at least part of the control program stored in the disk 11 to the SRAM 174 or the DRAM 18 by, for example, executing the IPL after power is supplied to the HDD.

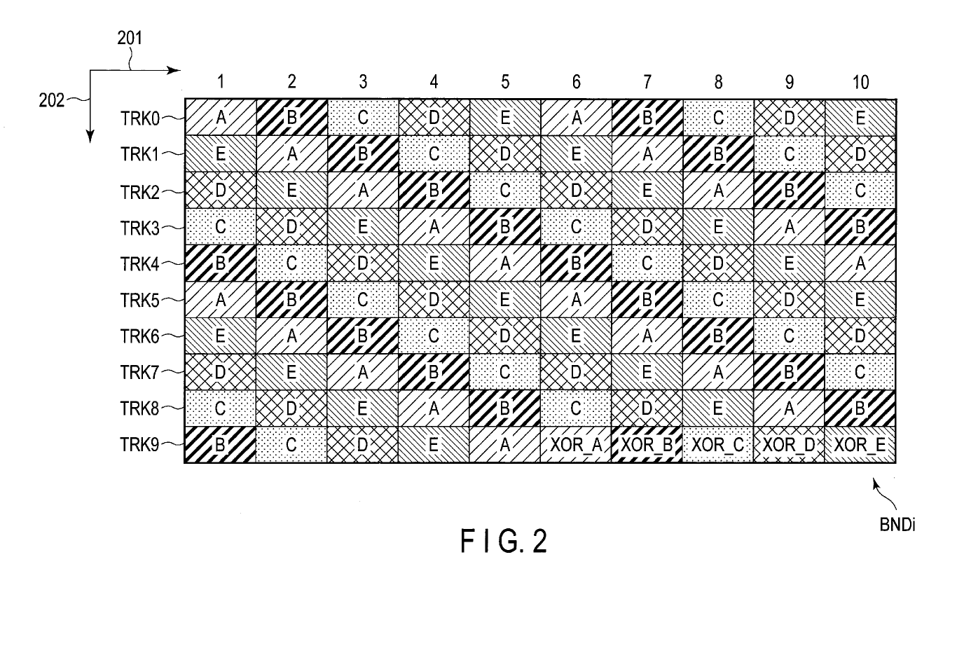

FIG. 2 shows an example of a set of groups in band BNDi on the disk 11. In FIG. 2, arrows 201 and 202 indicate the circumferential direction and radial direction of the disk 11, respectively. Furthermore, in FIG. 2, minimum rectangles with characters A, B, C, D and E indicate sectors A, B, C, D and E that are grouped into (belong to) groups A, B, C, D and E, respectively. Assume, for convenience of drawing, that band BNDi shown in FIG. 2 includes ten tracks TRK0 to TRK9 each including ten sectors. Although tracks TRK0 to TRK9 are actually of a concentric circular form, they are expressed in a straight form for facilitating the drawing in FIG. 2. In general, band BNDi includes more than ten tracks, and each track includes more than ten sectors.

A set of sectors in leading track TRK0 of band BNDi is grouped into groups A, B, C, D and E in this order in accordance with a first grouping rule. That is, on track TRK0 of band BNDi, sectors A, B, C, D and E belonging to groups A, B, C, D and E, respectively, are arranged in this order from the leading sector position of track TRK0.

In the embodiment in which the shift is one sector, in subsequent track TRK1 of band BNDi, groups (sectors) A, B, C, D and E are arranged in this order, shifted in position by one sector compared to their corresponding positions on track TRK0.

Similarly, on track TRK2 of band BNDi, groups (sectors) A, B, C, D and E are arranged in this order, shifted in position by one sector compared to their corresponding positions on track TRK1. Thus, whenever the track in band BNDi is switched from one to another, groups (sectors) A, B, C, D and E in band BNDi are arranged in this order, shifted in position by one sector. The arrangement involving the group-position shifting returns to an initial state every m tracks, m (=5) being equal to the number of groups. That is, the groups are aligned in position at each interval corresponding to m sequential tracks. Accordingly, the positions of groups (sectors) A, B, C, D and E on track TRK5, for example, coincide with those of groups (sectors) A, B, C, D and E on track TRK0. Namely, the positions of groups (sectors) A, B, C, D and E on tracks TRK5 to TRK9 coincide with those of groups (sectors) A, B, C, D and E on tracks TRK0 to TRK4, respectively.

In the areas corresponding to the 6^{th} to 10^{th} (last) sector positions in last track TRK9 of band BNDi, five XOR sectors corresponding to groups A, B, C, D and E are arranged, for example, in this order. XOR data XOR_j is stored in an XOR sector corresponding to group j (j=A, B, C, D, E). As aforementioned, XOR data XOR_j is generated by sequentially performing an XOR operation, bit by bit, on data of all sectors (data sectors) in group j.

In the arrangement of set of groups and sectors in band BNDi shown in FIG. 2, data sectors belonging to groups A, B, C, D and E are arranged one by one in the direction indicated by arrow 201 (in the circumferential direction of the disk 11). Therefore, five arbitrary sectors continuously arranged on track TRKp (p=0, 1, . . . , 9) in band BNDi all belong to different groups, regardless of their positions. Moreover, in band BNDi shown in FIG. 2, the group position is shifted by one sector between sequential tracks. Accordingly, in band BNDi, five arbitrary sectors continuously arranged in the direction indicated by arrow 202 (in the radial direction of the disk 11) belong to different groups, regardless of their positions.

By the way, in general, an error correction code (ECC) is attached to each data sector. The ECC is used, during a read from a data sector, to determine whether read data is correct, and to correct the read data if it is not correct. However, there may be a case where a read error that cannot be corrected even by the ECC is detected during a read from a data sector because of, for example, a flaw on the data sector (that is, a flaw in an area on the disk 11 corresponding to the data sector).

Even in such a case, if group j includes only one data sector that cannot be corrected, namely, only one defective sector, data in this defective sector can be recovered based on the remaining data sectors in group j and an XOR sector corresponding to group j. In contrast, if group j includes two or more defective sectors, the data of these defective sectors cannot be recovered generally.

Assume here that in band BNDi shown in FIG. 2, a single flaw has occurred in the direction of arrow 201, and that the flaw extends, for example, through five sectors continuously arranged in the direction of arrow 201. In this case, during a read from band BNDi, the above-mentioned five continuous sectors may be detected as defective sectors. However, the number of defective sectors in each of groups A, B, C, D and E is one at most. Therefore, the data of the defective sectors in groups A, B, C, D and E can be recovered.

Assume then that a single flaw has occurred in the direction of arrow 202 (namely, in the radial direction of the disk 11), and that the flaw extends, for example, through five sectors continuously arranged in the direction of arrow 202. Also in this case, the number of sectors, which may be detected as defective sectors because of the flaw, is one at most in each of groups A, B, C, D and E. Therefore, the data of the defective sectors in groups A, B, C, D and E can be recovered.

In contrast, assume a case where a set of data sectors are collectively arranged in each group, unlike the embodiment. In this arrangement, assume that the above-mentioned flaw extends through, for example, five sectors continuously arranged in the direction of arrow 201 or in the direction of arrow 202. In this case, the number of sectors, which may be detected as defective sectors because of the flaw, is more than one within a group corresponding to the range of the flaw. Therefore, the data of the defective sectors in this group cannot be recovered.

Assume another case where data sectors belonging to groups A, B, C, D and E are arranged in order in each track in band BNDi, but tracks TRK0 to TRK9 in band BNDi are identical in group position, unlike the embodiment. In this arrangement, assume that the above-mentioned flaw extends through five tracks continuously arranged in, for example, the direction of arrow 202. In this case, the number of sectors, which may be detected as defective sectors because of the flaw, is more than one within a group corresponding to the range of the flaw. Therefore, the data of the defective sectors in this group cannot be recovered.

In the embodiment, the number of groups is 5. However, the number of groups may be more than 5, or may be two, three or four. The larger the number of groups, the wider the range of dispersion of data sectors, and hence the lower the probability of occurrence of defective sectors in the same group. However, the greater the number of groups, the greater the number of XOR sectors, and hence the fewer the data sectors in band BNDi. This means that the larger the number of groups, the smaller the storage capacity of the HDD shown in FIG. 1.

In the arrangement of set of groups and sectors in band BNDi shown in FIG. 2, more than one defective sectors will occur in the same group at a certain probability. This may occur, for example, when a flaw extends obliquely with respect to the directions of arrows 201 and 202. Such an oblique flaw may occur when the head 12 collides with the disk 11 during a seek operation for moving the head 12 on the disk 11. Moreover, it also may occur when a plurality of flaws exist in band BNDi. In order to enhance the fault recovery capability of the HDD in the above-mentioned state, band BNDi may have at least two overlapping sets of groups, to which different grouping rules are applied. More specifically, in addition to the set of groups shown in FIG. 2 (hereinafter, referred to as a first set of groups), band BNDi may have another set of groups (hereinafter, referred to as a second set of groups) to which a second grouping rule different from the first grouping rule is applied.

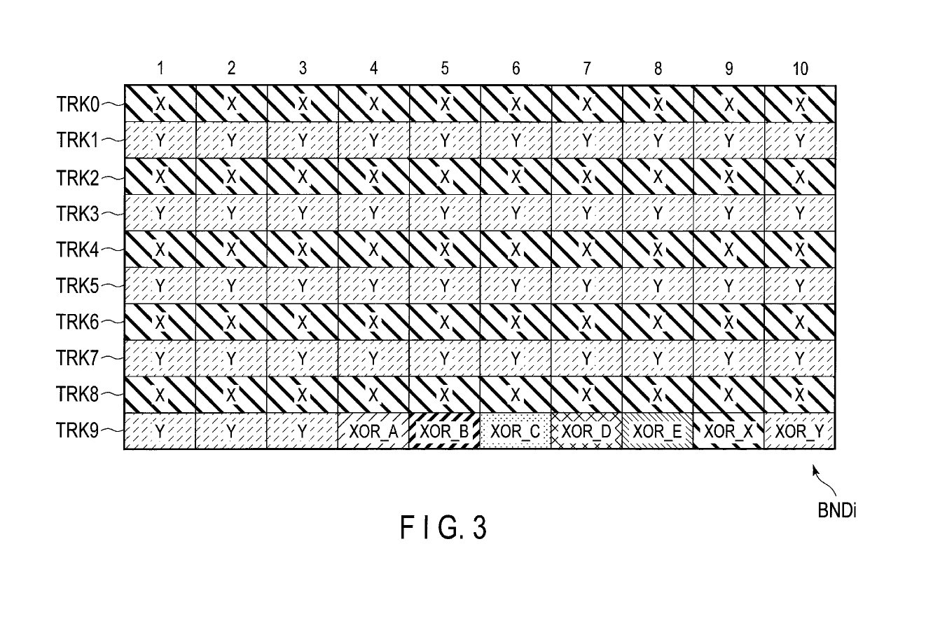

FIG. 3 shows an example of the second set of groups in band BNDi in a case where band BNDi has the second set of groups in addition to the first set of groups. In the second set of groups, data sectors belonging to group X are arranged in even-numbered tracks TRK0, TRK2, TRK4, TRK6 and TRK8 of band BNDi. On the other hand, data sectors belonging to group Y are arranged in odd-numbered tracks TRK1, TRK3, TRK5, TRK7 and TRK9 of band BNDi.

In the second set of groups, XOR data XOR_X corresponding to group X is generated based on the data of the data sectors of group X, and XOR data XOR_Y corresponding to group Y is generated based on the data of the data sectors of group Y. Accordingly, when band BNDi has the first and second sets of groups, it needs at least seven XOR sectors for storing XOR data XOR_A, XOR_B, XOR_C, XOR_D, XOR_E, XOR_X, and XOR_Y. The seven XOR sectors correspond to groups A, B, C, D, E, X and Y, and are arranged in, for example, areas corresponding to the 4^{th} to 10^{th} sector positions in last track TRK9 of band BNDi. Therefore, when band BNDi has the first and second sets of groups, the 4^{th} to 10^{th} sectors on track TRK9 shown in FIG. 2 should be replaced with the seven XOR sectors for storing XOR data XOR_A, XOR_B, XOR_C, XOR_D, XOR_E, XOR_X and XOR_Y, as in the case of FIG. 3.

In band BNDi having the first and second sets of groups, each data sector belongs to one of group A, B, C, D and E and also to one of groups X and Y in an overlapping manner (FIGS. 2 and 3). Therefore, even if, for example, two sectors belonging to group A in the first set of groups are detected as defective sectors, the data of the two defective sectors can be recovered when the following conditions are satisfied. That is, if the two defective sectors separately belong to groups X and Y in the second set of groups, the data of the two defective sectors can be recovered using the data of the respective XOR sectors corresponding to groups X and Y.

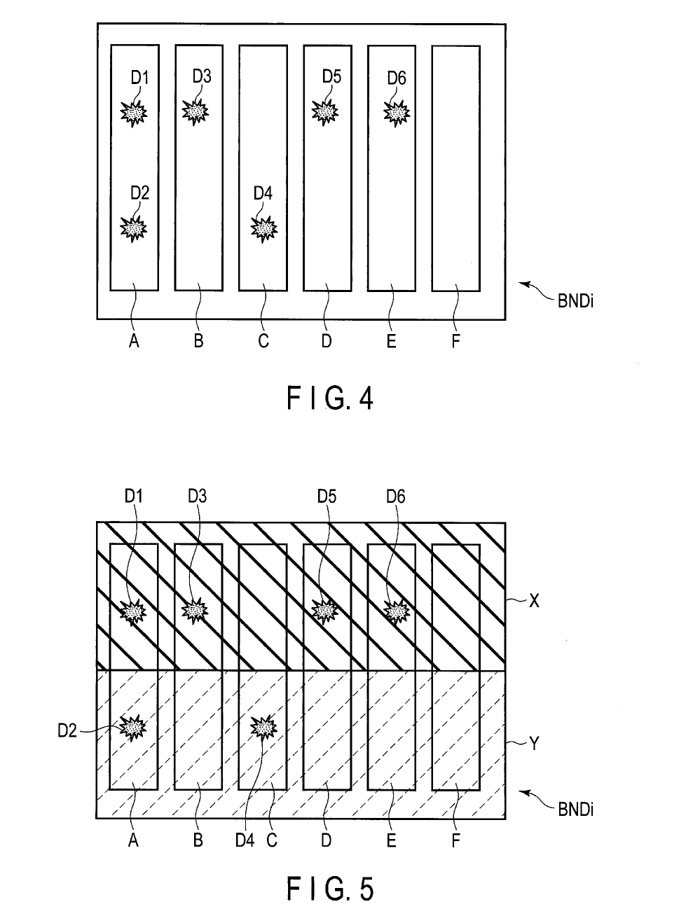

Referring now to FIGS. 4 and 5, a description will be given of an effect obtained when band BNDi has the first and second sets of groups. FIG. 4 shows examples of the first set of groups and defective sectors in a case where band BNDi has only the first set of groups. It should be noted that in FIG. 4, rectangles representing groups A, B, C, D and E logically express a set of data sectors belonging thereto and do not express the physical positions of groups A, B, C, D and E.

In FIG. 4, D1 to D6 represent defective sectors. Defective sectors D1 and D2 both belong to group A. In contrast, defective sectors D3, D4, D5 and D6 belong to groups B, C, D and E, respectively. Namely, in each of groups B, C, D and E, only one data sector is detected as a defective sector, while in group A, two data sectors are detected as defective sectors. In this case, the data of defective sector D3, D4, D5 and D6 in groups B, C, D and E can be recovered using the XOR sectors corresponding to groups B, C, D and E. However, the data of two defective sectors D1 and D2 in group A cannot be recovered even using the XOR sector corresponding to group A.

FIG. 5 shows examples of the first and second sets of groups and defective sectors in a case where band BNDi has the second set of groups in addition to the first set of groups. In FIG. 5, the relationship between groups A, B, C, D and E in the first set of groups and defective sectors D1 to D6 is the same as in FIG. 4. Further, in FIG. 5, defective sectors D1, D3, D5 and D6 belonging to groups A, B, D and E also belong to group X. In contrast, defective sectors D2 and D4 belonging to groups A and C, respectively, also belong to group Y.

The data of defective sector D3, D4, D5 and D6 can be recovered using the XOR sectors corresponding to group B, C, D and E as mentioned above. In the example of FIG. 5, if the data of defective sectors D3, D4, D5 and D6 can be recovered, the data of defective sectors D1 and D2 can also be recovered using the XOR sectors corresponding to groups X and Y, respectively. Thus, band BNDi has the second set of groups in addition to the first set of groups, which enhances the fault recovery capability of the HDD.

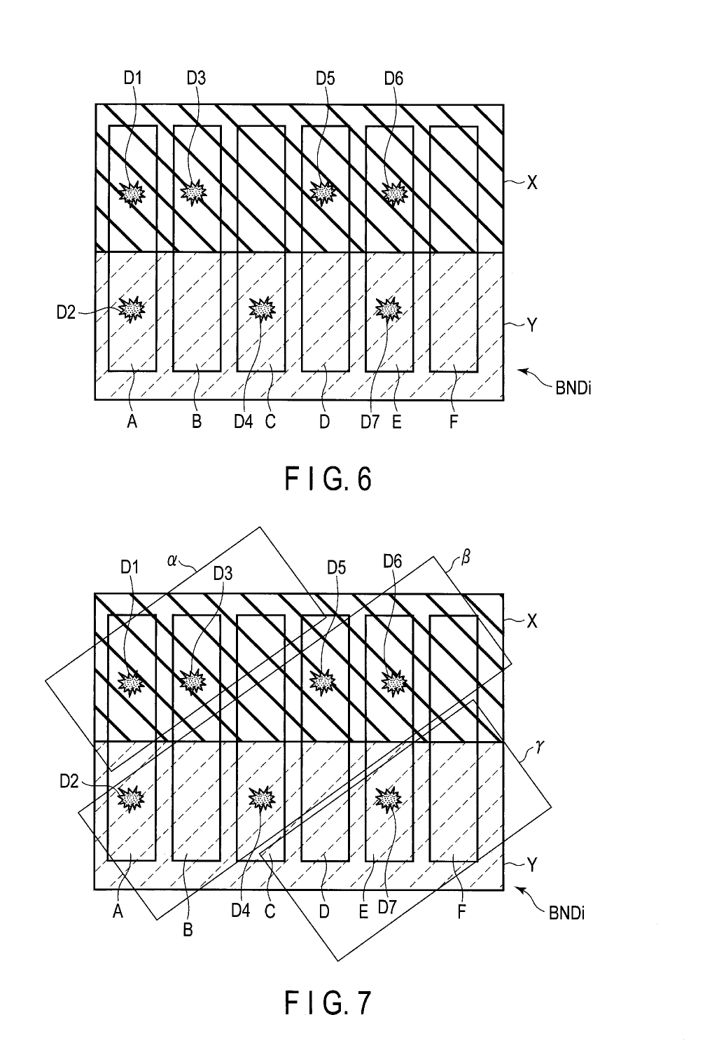

However, if, for example, the number of defective sectors is greater than in the case of FIG. 5, the data of some defective sectors including defective sectors D1 and D2 may be unable to be recovered. FIG. 6 shows examples of the first and second sets of groups and defective sectors in a case where the number of defective sectors is greater by one than in the case of FIG. 5. In FIG. 6, D7 represents an additional defective sector. Defective sector D7 belongs to groups E and Y. That is, two defective sectors D6 and D7 belong to group E. In this case, although the data of defective sector D3, D4, and D5 can be recovered, the data of defective sector D6 cannot be recovered even using the XOR sector corresponding to group E. Therefore, the data of defective sectors D1 and D2 cannot be recovered even using the XOR sectors corresponding to groups X and Y.

FIG. 7 shows examples of the first to third sets of groups and defective sectors in a case where band BNDi has the third set of groups in addition to the first and second sets of groups. For the third set of groups, a third grouping rule different from the first and second grouping rule is applied. In FIG. 7, the relationship between group A, B, C, D and E in the first set of groups and defective sectors D1 to D7, and the relationship of groups X and Y in the second set of groups and defective sectors D1 to D7, are the same as in the case of FIG. 6. Moreover, in FIG. 7, band BNDi additionally has the third set of groups including three groups a, and y, in addition to the first and second sets of groups.

In the example of FIG. 7, defective sectors D1 and D3 also belong to group a, and defective sector D2, D4, D5 and D6 also belong to group p. Further, defective sector D7 also belongs to group y. In this case, the data of defective sector D7 can be recovered using the XOR sector corresponding to group y. Since band BNDi after the data of defective sector D7 is recovered assumes a state similar to that of FIG. 5, the data of all remaining defective sectors D1 to D6 can be recovered. Band BNDi may have four or more sets of groups.

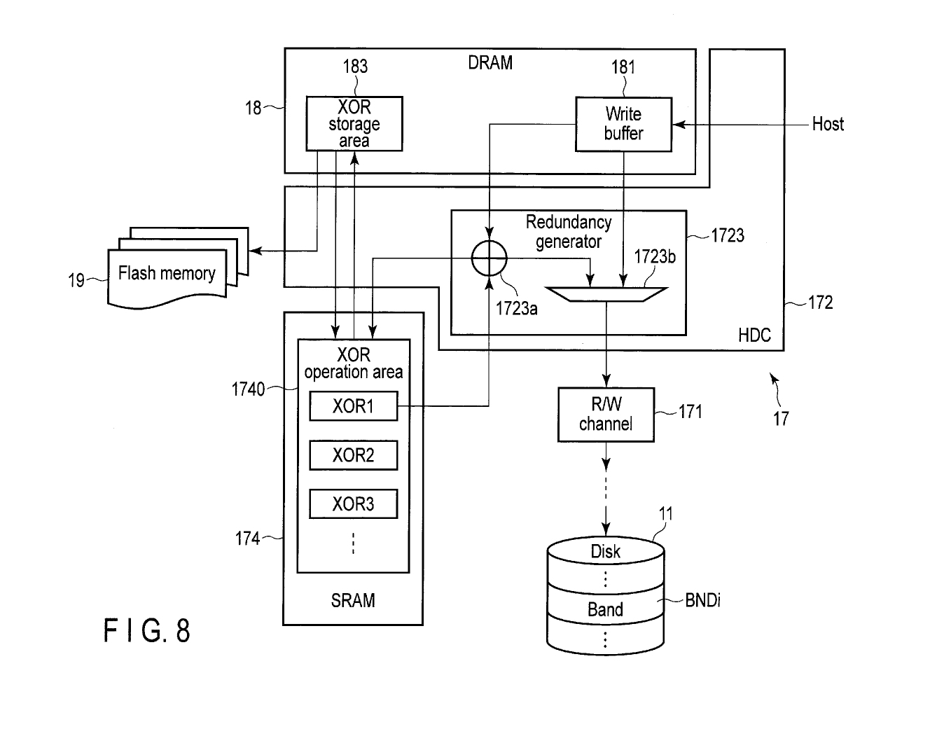

FIG. 8 is a block diagram showing a configuration of the HDD, shown in FIG. 1, related to the XOR operation. FIG. 8 does not show the MIF controller 1721 and the sequencer 1722 in the HDC 172. In the description below, it is assumed that band BNDi has a first set of groups as shown in, for example, FIG. 2.

The XOR storage area 183 in the DRAM 18 is used for storing the XOR data (more specifically, newest XOR data) of all groups in the first set of groups. That is, the XOR storage area 183 has a size Ss sufficient to store the XOR data of all groups. The XOR data of all groups stored in the XOR storage area 183 is saved to, for example, the flash memory 19 when the power to the HDD is interrupted.

The XOR operation area 1740 in the SRAM 174 is used for storing a copy of the XOR data, selected from the XOR storage area 183, as XOR data used for a near future XOR operation. The XOR operation area 1740 does not necessarily need to have the size Ss.

The redundancy generator 1723 in the HDC 172 includes an XOR (exclusive OR) operation circuit 1723a and a selector 1723b. The XOR operation circuit 1723a executes an XOR operation bit by bit between data q to be grouped into group j (j=A, B, C, D, E) (more specifically, data corresponding to the sector size) and XOR data of group j read from the XOR operation area 1740, when the data q is read from the write buffer 181 and written to band BNDi. The XOR data of group j in the XOR operation area 1740 is updated to the result of the XOR operation, and the XOR data (XOR_j) of group j in the XOR storage area 183 is updated to the updated XOR data.

The selector 1723b selects, as data to be written to band BNDi, the data q retrieved from the write buffer 181, or the result (XOR data) of the XOR operation by the XOR operation circuit 1723a. The selected data is sent to the R/W channel 171, and is written (additionally written) to band BNDi through the head IC 16.

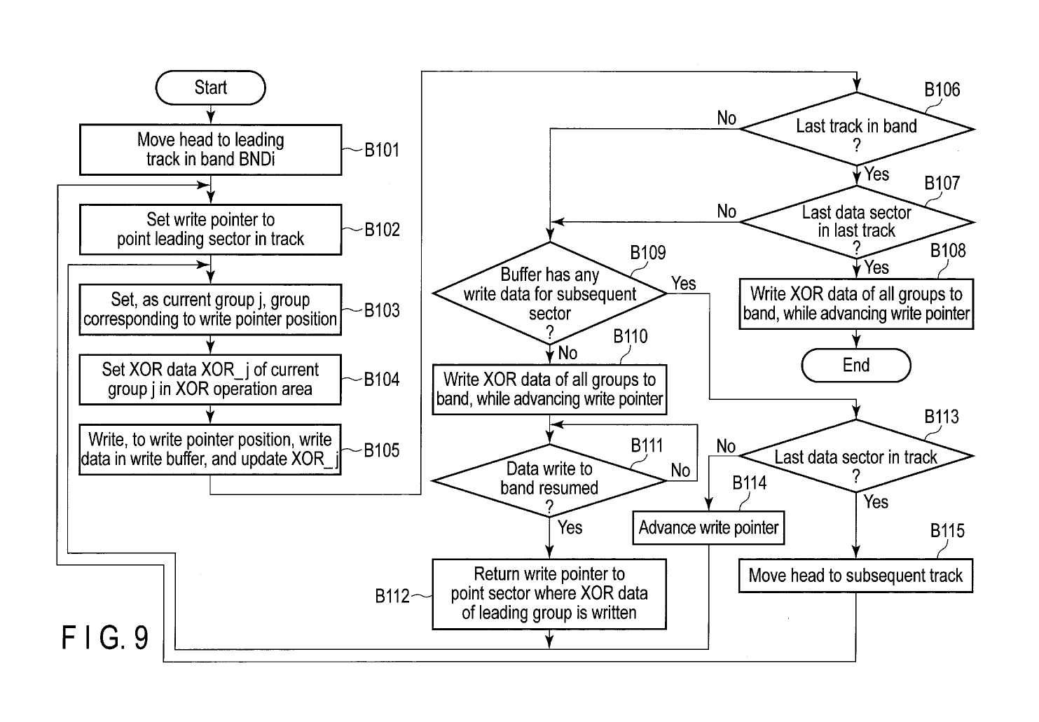

Referring then to FIG. 9, a description will be given of write processing for writing data (user data) to band BNDi in the embodiment. FIG. 9 is a flowchart showing an exemplary procedure of write processing. The write processing includes writing, to band BNDi, of the result (XOR data) of the XOR operation by the XOR operation circuit 1723a of FIG. 8 (namely, generation and arrangement of the XOR sector).

Assume here that the CPU 173 starts write processing for writing data to band BNDi on the disk 11 in accordance with a write command from the host. At this time, the CPU 173 controls the VCM 140 via the driver IC 15 to thereby move the head 12 to leading track TRK0 of band BNDi (B101). Subsequently, the CPU 173 transfers control to the sequencer 1722 in the HDC 172.

The sequencer 1722 sets a write pointer so that it points a leading sector on track TRKp (in this example, track TRKp0, i.e., p=0) to which the head 12 has been moved (B102). The write pointer is set in, for example, a particular register in the HDC 172.

Subsequently, based on the group-order parameter and the shift parameter held in the management table 182 in association with band BNDi, the sequencer 1722 determines a group corresponding to the position of the write pointer, and sets the determined group as a present group j (B103). Assume here that the present group j is group A. At this time, the XOR storage area 183 stores the initial values (initial XOR data) of the XOR data of groups A, B, C, D and E in the first set of groups. All bits of initial XOR data are, for example, 0. Subsequently, the sequencer 1722 selects XOR data XOR_j (=XOR_A) corresponding to the present group j from the XOR storage area 183, and sets a copy of XOR data XOR_j in, for example, an XOR1 (XOR1 area) in the XOR operation area 1740 (B104).

Subsequently, the sequencer 1722 retrieves, from the write buffer 181, data to be written to a sector position (namely, a write pointer position) on band BNDi pointed by the write pointer, and writes the retrieved data to the write pointer position on band BNDi (B105). More specifically, the sequencer 1722 causes the head 12 to write the retrieved data to the write pointer position on band BNDi via the selector 1723b, the R/W channel 171 and the head IC 16. Thus, a data sector J belonging to group j is located at the write pointer position.

Further, in B105, the sequencer 1722 selects XOR data XOR_j (for example, XOR data XOR_A in area XOR1) corresponding to the current group j from the XOR operation area 1740, and causes the XOR operation circuit 1723a to execute an XOR operation bit by bit between the selected XOR data XOR_j and the retrieved data. Furthermore, in B105, the sequencer 1722 updates the XOR data in the XOR operation area 1740 used for the XOR operation, to the result of the XOR operation by the XOR operation circuit 1723a.

As described above, band BNDi is used as a write once type access area. This means that data overwriting does not occur in writing data (user data) to band BNDi. More specifically, writing of data to band BNDi is sequentially performed sector by sector from the leading sector position of a leading track in band BNDi to the last data sector position of a last track in band BNDi. Therefore, whenever data to be grouped into group j is retrieved from the write buffer 181 and written to band BNDi, the XOR operation circuit 1723a performs an XOR operation based on the retrieved data. After that, the sequencer 1722 updates the XOR data XOR_j to the operation result, thereby acquiring target XOR data XOR_j.

Note that if the retrieved data is first data to be grouped into group j, the selected XOR data XOR_j is initial XOR data. In this case, the result of the XOR operation coincides with the retrieved data. If the retrieved data is the m^{th} data (m is an integer greater than 1) to be grouped into group j, the selected XOR data XOR_j coincides with the result of the XOR operation obtained when the m−1^{th} data to be grouped into group j is retrieved. Further, in B105, the sequencer 1722 updates XOR data XOR_j in the XOR storage area 183 to the updated XOR data in the XOR operation area 1740.

Subsequently, the sequencer 1722 determines whether the write pointer position is in the last track of band BNDi (B106). If the write pointer position is not in the last track (No in B106), the sequencer 1722 proceeds to B109.

In contrast, if the write pointer position is in the last track (Yes in B106), the sequencer 1722 determines whether the write pointer points a last data sector in the last track (B107). The last data sector in the last track refers to a sector located in the last track immediately before continuous sectors whose number is identical to the number (=5) of groups included in the first set of groups, if band BNDi includes the first set of groups. This is because the continuous sectors, in the last track, whose number is identical to the number (=5) of groups are used as XOR sectors, as is evident from, for example, FIG. 2. If the write pointer does not point the last data sector in the last track (No in B107), the sequencer 1722 proceeds to B109, as in the case of No in B106.

In B109, the sequencer 1722 determines whether write data for a sector subsequent to the write pointer position is stored in the write buffer 181. If the answer in B109 is Yes, the sequencer 1722 determines whether the write pointer points a last data sector in a track (more specifically, a track other than the last track) in which the head 12 is currently positioned (B113).

If the answer in B113 is No, the sequencer 1722 advances the write pointer by one sector (B114), and returns to B103. In contrast, if the answer in B113 is Yes, the sequencer 1722 returns control to the CPU 173. At this time, the CPU 173 controls the VCM 140 via the driver IC 15 to move the head 12 to a subsequent track in band BNDi (B115), and then transfers control to the sequencer 1722. Thereby, the sequencer 1722 returns to B102.

In contrast, if the answer in B109 is No, the sequencer 1722 proceeds to B110. In B110, the sequencer 1722 writes (saves), to band BNDi in the order mentioned, the newest XOR data of all groups, for example, XOR_A, XOR_B, XOR_C, XOR_D and XOR_E, currently stored in the XOR storage area 183, while advancing the write pointer sector by sector. That is, the sequencer 1722 generates XOR sectors in which XOR data XOR_A, XOR_B, XOR_C, XOR_D and XOR_E are held. Subsequently, the sequencer 1722 continuously arranges the generated XOR sectors in sector areas (namely, free sector areas with no data sectors) subsequent to a lastly arranged data sector (namely, a last data sector to which user data is written).

Subsequently, the sequencer 1722 waits for a state where subsequent write data is transferred from the host to the HDD to enable a write (additional write) to band BNDi to be resumed (B111). If resumption of the write to band BNDi becomes possible (Yes in B111), the sequencer 1722 returns the write pointer to point a sector position where XOR data XOR_A of leading group A is written (B112). After that, the sequencer 1722 returns to B103.

Assume here that data has been written to the last data sector position in the last track of band BNDi, and XOR data XOR_j has been updated (B105). That is, it is assumed that writing of the user data to band BNDi is complete. In this case, both answers in B106 and B107 are Yes, and the sequencer 1722 writes, to band BNDi in the order mentioned, the XOR data of all groups, i.e., XOR_A, XOR_B, XOR_C, XOR_D and XOR_E, currently stored in the XOR storage area 183, while advancing the write pointer sector by sector, as in B110 (B108). This is the termination of the write processing.

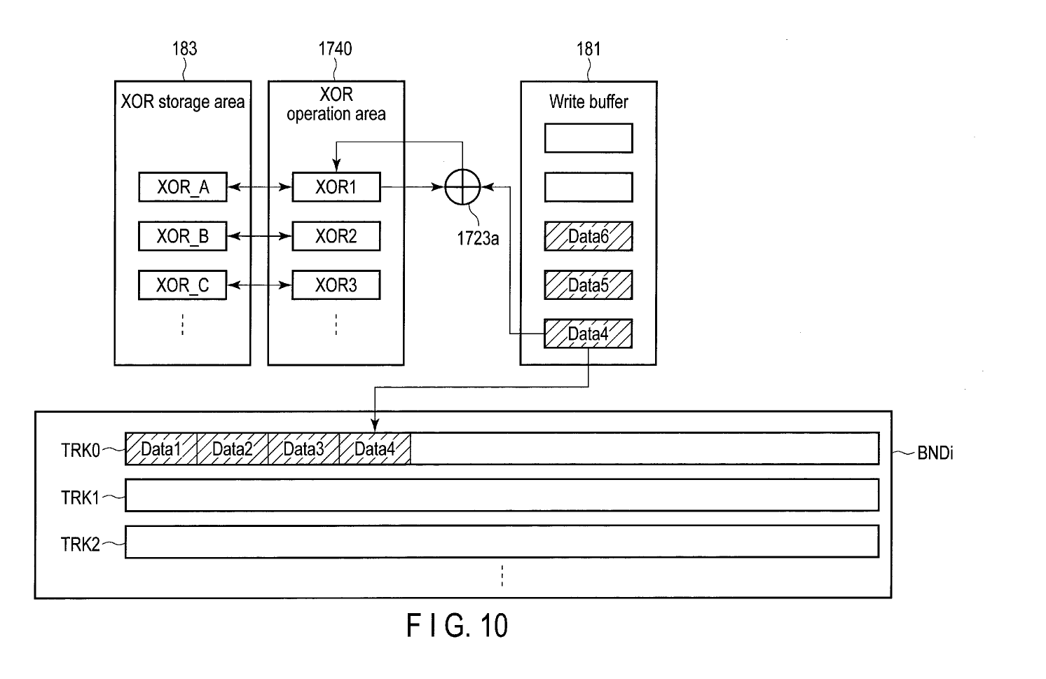

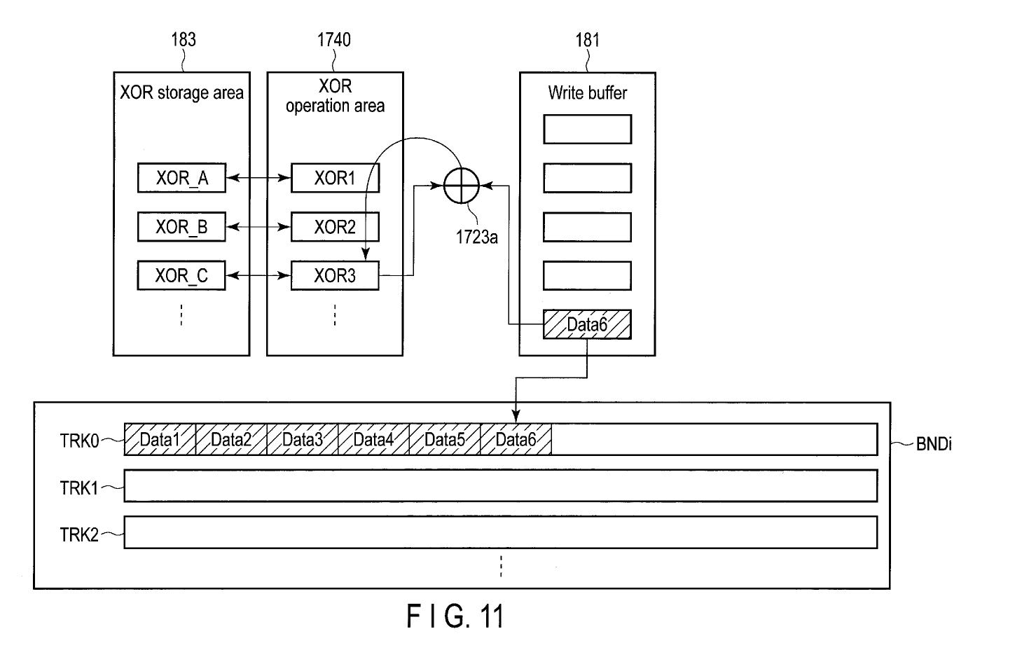

Referring then to FIGS. 10 to 13, a description will be given of a specific example of the above-described write processing. However, for simplifying the description, FIGS. 10 to 13 show an example of the first set of groups, which includes groups A, B and C, unlike the FIG. 2 example of the first set of groups. FIGS. 10 to 13 are views for explaining examples of each XOR data processing executed at first to fourth time points of the write processing.

Assume firstly that data items 1 to 3 included in data items 1 to 6 specified by a first write command from the host are already written to first to third sector positions on track TRK0 of band BNDi, as is shown in FIG. 10. Assume further that at a first time point after that, data item 4 is retrieved from the write buffer 181, and is written to a 4th sector position on track TRK0. Data items 1 to 6 and data items 7 to 9, described later, are user data divided sector by sector. If a set of groups comprising groups A, B and C is supposed to be employed, data items 1 and 4 belong to group A, data items 2 and 5 belong to group B, and data items 3 and 6 belong to group C.

In a state where data items 1 to 3 are already written to first to third sector positions on track TRK0 of band BNDi, XOR data items XOR_A, XOR_B and XOR_C generated (updated) based on data items 1, 2 and 3 are stored in the XOR storage area 183 as shown in FIG. 10. Namely, newest XOR data items of all groups are stored in the XOR storage area 183. XOR data items XOR_A, XOR_B, and XOR_C at this time coincide with data items 1, 2, and 3, respectively.

Moreover, as shown in FIG. 10, newest XOR data items XOR_A, XOR_B, and XOR_C are also stored in XOR1, XOR2 and XOR3 of the XOR operation area 1740, respectively. However, the XOR operation area 1740 may not necessarily have a size Ss sufficient to store the XOR data of all groups. In this case, however, the flow of write processing may interrupt for exchange of the XOR data in the XOR operation area 1740. In view of this, while the XOR operation circuit 1723a is performing an XOR operation based on the XOR data and user data of a certain group, the sequencer 1722 may copy the XOR data of other groups from the XOR storage area 183 to the XOR operation area 1740. By such pipeline processing, the flow of write processing can be prevented from interruption even if the XOR operation area 1740 does not have a size Ss sufficient for storing the XOR data of all groups.

When data item 4 retrieved from the write buffer 181 is written as sector data of group A to the 4th sector position of track TRK0, the XOR operation circuit 1723a performs an XOR operation between data item 4 and data (XOR data XOR_A) in XOR1 of the XOR operation area 1740, as is shown in FIG. 10. XOR data XOR_A in XOR1 is updated to the result of the XOR operation. Updated XOR data XOR_A is copied to the original position of data XOR_A in the XOR storage area 183. That is, XOR data XOR_A in the XOR storage area 183 is also updated to the result of the XOR operation based on data item 4 of group A.

Subsequently, assume that data item 5 is written as sector data of group B to the 5th sector position of track TRK0. In this case, at a second time point thereafter, data item 6 is written as sector data of group C to the 6th sector position of track TRK0, as is shown in FIG. 11.

In this case, the XOR operation circuit 1723a performs an XOR operation between data item 6 and data (XOR_C) in XOR3 of the XOR operation area 1740, as is shown in FIG. 11. The data (XOR_C) in XOR3 and XOR data XOR_C in the XOR storage area 183 are updated to the result of this XOR operation.

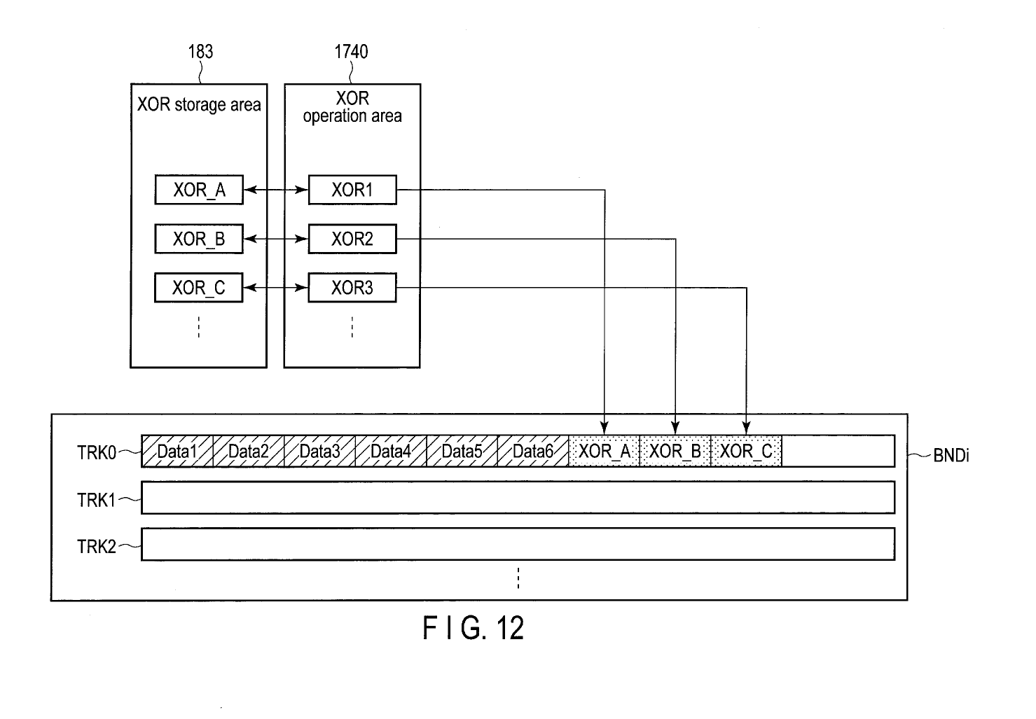

In FIG. 11, there is no subsequent write data in a state where data item 6 is written to band BNDi (No in B109 in FIG. 9), and hence an additional write to band BNDi is interrupted. In this case, as shown in FIG. 12, the sequencer 1722, for example, writes XOR data XOR_A, XOR_B and XOR_C, stored in the XOR storage area 183 at the interruption of additional writing (at the third time point), to sector areas subsequent to a sector position in band BNDi, where user data (data item 6) is lastly written (B110 in FIG. 9).

By this writing, newest XOR data XOR_A, XOR_B and XOR_C, which are now being additionally written, are saved in band BNDi. Alternatively, XOR data XOR_A, XOR_B and XOR_C in XOR1, XOR2 and XOR3 of the XOR operation area 1740 may be used for this writing.

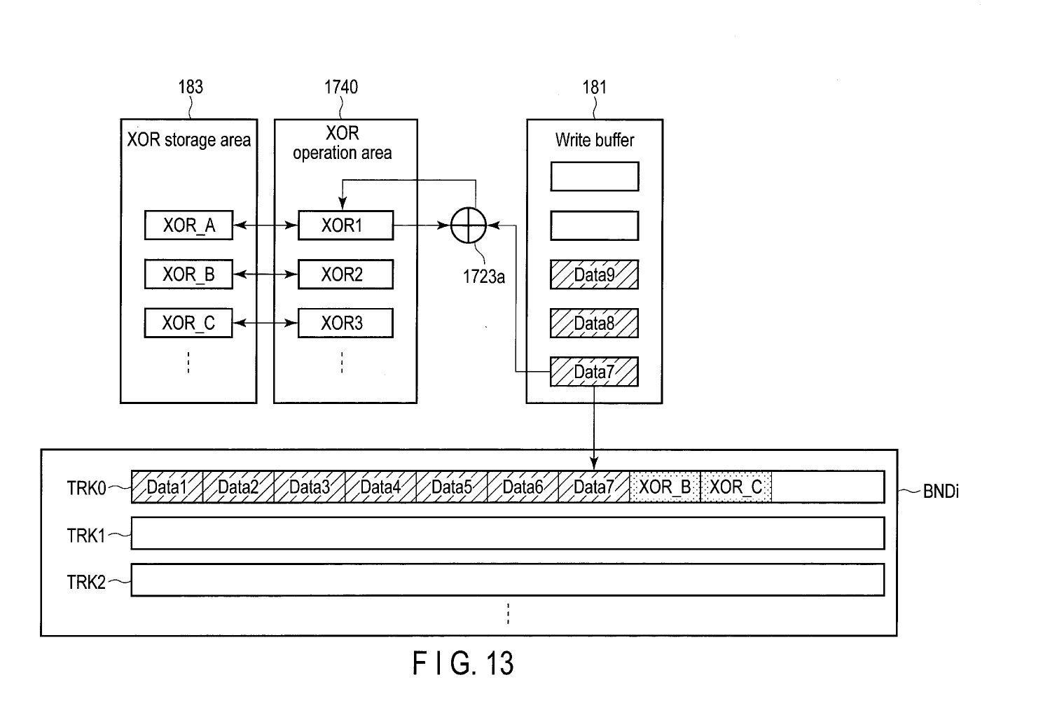

Subsequently, it is assumed that as shown in FIG. 13, subsequent data items 7 to 9 specified by a second write command from the host are stored in the write buffer 181, thereby resuming additional writing (Yes in B111). At this time, as shown in FIG. 13, data item 7 is written as sector data of group A to the 7th sector position of track TRK0 at a 4th time point (B112, B103 to B105). That is, data item 7 is overwritten to the 7th sector position where XOR data XOR_A, which is now being additionally written, is saved.

In this case, the XOR operation circuit 1723a performs an XOR operation between data item 7 and data (XOR_A) in XOR1 of the XOR operation area 1740, as shown in FIG. 13. The data (XOR_A) in XOR1 is updated to the result of the XOR operation, and XOR data XOR_A in the XOR storage area 183 is also updated to the result of the XOR operation. After that, subsequent data items 8 and 9 are written to the 8th and 9th sector positions of track TRK0, although not shown in FIG. 13. Namely, data items 8 and 9 are overwritten to the 8th and 9th sector positions where XOR data XOR_B and XOR_C, which are now being additionally written, are saved.

XOR data XOR_A, XOR_B and XOR_C saved in the 7th, 8^{th} and 9^{th} sector positions of track TRK0 become old and unnecessary because of the resumption of additional writing. The above-mentioned overwriting is executed to secure the storage capacity of the HDD. By the overwriting, the sectors temporarily used as XOR sectors are again used as data sectors. Note that band BNDi is used as a write once type access area, and is therefore overwritten with no user data.

Assume here that the power to the HDD is interrupted before newest XOR data is written to band BNDi. At this time, XOR data in the XOR storage area 183 and the XOR operation area 1740 disappears. Therefore, in the embodiment, in an abnormal state where the power to the HDD is suddenly interrupted, the sequencer 1722 saves, to the flash memory 19, the XOR data of all groups stored in the XOR storage area 183 (or XOR operation area 174), along with a write pointer. Alternatively, data indicating to which sector on the disk 11 writing has been performed may be attached in place of saving the write pointer.

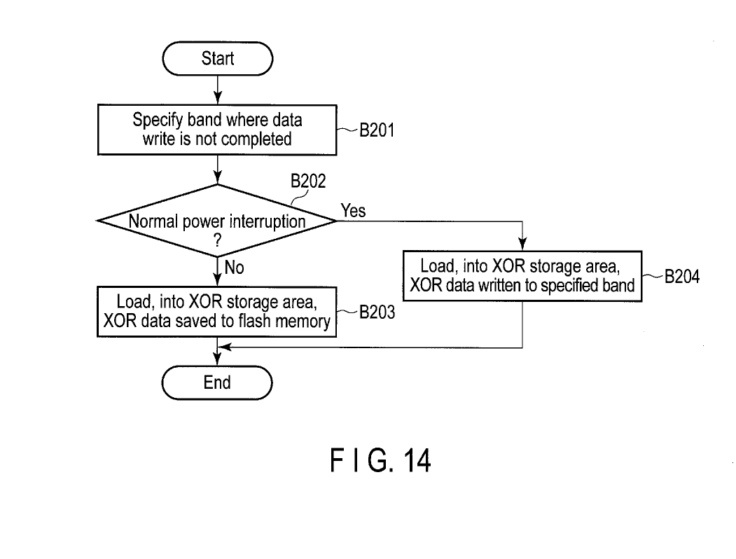

Subsequently, XOR-data load processing for loading, into the XOR storage area 183, the XOR data saved to the flash memory 19 will be described with reference to FIG. 14. FIG. 14 is a flowchart showing an exemplary procedure of the XOR-data load processing in the embodiment.

Assume here that power is again supplied to the HDD after the interruption of the power thereto, thereby resuming an additional write to a band. In this case, the CPU 173 instructs the sequencer 1722 to execute XOR-data load processing. The sequencer 1722, in turn, refers to the management table to check whether there is a band in which a write is not yet complete (namely, a band in which an additional write is now being executed). If there is a band in which an additional write is now being executed, the sequencer 1722 specifies the band (B201). That is, the sequencer 1722 acquires a logical address (for example, a logic block address) and a physical address associated with the band.

Subsequently, the sequencer 1722 determines whether preceding power interruption was normal (B202). Normal power interruption refers to, for example, a state where power is interrupted, with the head 12 retracted in accordance with a standby command from the host. In contrast, abnormal power interruption refers to, for example, a state where the power to the HDD is stopped suddenly during writing. In the embodiment, the CPU 173 stores data indicating abnormal power interruption, for example, flag data, in a particular area of the flash memory 19, upon detection of the abnormal power interruption. Referring to the particular area of the flash memory 19, the sequencer 1722 determines whether power interruption was normal (B202).

If the power interruption was not normal (No in B202), the sequencer 1722 determines that XOR data (more specifically, the XOR data of all groups in a specified band) stored in the XOR storage area 183 is saved to the flash memory 19. In this case, the sequencer 1722 loads, into the XOR storage area 183, the XOR data saved to the flash memory 19 (B203), thereby finishing the XOR-data load processing.

In contrast, if the power interruption was normal (Yes in B202), the sequencer 1722 loads, into the XOR storage area 183, the XOR data of all groups associated with the specified band and written therein (B204). For this loading, the sequencer 1722 acquires, from the managed table 182, the physical addresses of the sector positions in which the XOR data of all groups associated with the specified band is stored. After executing B204, the sequencer 1722 finishes the XOR data load processing.

In the embodiment, XOR data associated with a band, in which data is being additionally written, is saved to the flash memory 19 upon detection of abnormal power interruption. Moreover, in the embodiment, XOR data is generated by hardware, such as the redundancy generator 1723 (XOR operation circuit 1723a) in the HDC 172. However, XOR data may be generated by processing by the CPU 173 using a program.

In the above-described at least one embodiment, it can be prevented as far as possible that two or more sectors are detected as error sectors in the same group.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a disk comprising a storage area including a plurality of tracks; and
a controller configured to group, data sector by data sector into a plurality of groups forming a first set of groups, a plurality of data sectors arranged on each of the plurality of tracks, such that those of the plurality of groups that are arranged at least adjacent to each other differ in position from each other, and to arrange a plurality of redundant sectors corresponding to the plurality of groups in a free area in the storage area.

2. The magnetic disk device of claim 1, wherein in accordance with a grouping rule different from a grouping rule used for the grouping, the controller groups a plurality of data sectors arranged on the plurality of tracks, into a plurality of groups forming a second set of groups, and arranges in the free area, the plurality of redundant sectors corresponding to the plurality of groups forming the first set of groups, and a plurality of redundant sectors corresponding to the plurality of groups forming the second set of groups.

3. The magnetic disk device of claim 1, wherein the free area is located subsequent to a data sector position in which a data sector where user data is recorded last is located.

4. The magnetic disk device of claim 1, wherein in accordance with a plurality of grouping rules different from each other and including a grouping rule for the grouping, the controller groups a plurality of data sectors arranged on the plurality of tracks, into respective pluralities of groups forming a plurality of sets of groups including the first set of groups, and arranges in the free area, respective pluralities of redundant sectors corresponding to the respective pluralities of groups.

5. The magnetic disk device of claim 1, further comprising a memory including a redundant data area for storing initial or intermediate data of redundant data corresponding to the plurality of groups,
wherein the controller generates new redundant data in accordance with arrangement, in the storage area, of a first data sector where first user data is recorded, based on first redundant data and the first user data, and updates the first redundant data to the generated redundant data, the first redundant data corresponding to a group to which the first data sector belongs, and being stored in the redundant data area.

6. The magnetic disk device of claim 5, wherein in accordance with interruption of additional writing of user data to the storage area, the controller arranges, in a first area of the storage area, a plurality of redundant sectors existing in the redundant data area and in which updated redundant data corresponding to the plurality of groups is recorded, the first area being located subsequent to a data sector position in which a data sector is located, and wherein in the data sector, user data is recorded immediately before the interruption.

7. The magnetic disk device of claim 6, wherein the controller resumes the additional writing from location of a data sector in which new user data is recorded, in a leading sector position of the first area.

8. The magnetic disk device of claim 5, further comprising a rewritable nonvolatile memory,
wherein the controller saves, to the nonvolatile memory updated redundant data corresponding to the plurality of groups and located in the redundant data area, in accordance with interruption of power to the magnetic disk device.

9. The magnetic disk device of claim 1, wherein in the grouping, the controller shifts positions of the plurality of groups for each track a given number of data sectors by a given number of data sectors.

10. The magnetic disk device of claim 9, wherein when number of the plurality of groups is m, an arrangement in which the plurality of groups differ in position returns to an initial state at each interval corresponding to m continuous tracks.

11. A controller, in a magnetic disk device including a disk comprising a storage area including a plurality of tracks, for controlling access to the disk, the disk controller comprising:
a redundancy generator configured to generate redundant data; and
a sequencer configured to group, data sector by data sector into a plurality of groups forming a first set of groups, a plurality of data sectors arranged on each of the plurality of tracks, such that those of the plurality of groups that are arranged at least adjacent to each other differ in position from each other, to cause the redundancy generator to generate redundant data corresponding to the plurality of the groups, and which arranges, in a free area in the storage area, a plurality of redundant sectors where the generated redundant data corresponding to the plurality of groups is recorded.

12. The controller of claim 11, wherein in accordance with a grouping rule different from a grouping rule used for the grouping, the sequencer groups a plurality of data sectors arranged on the plurality of tracks, into a plurality of groups forming a second set of groups, and arranges in the free area, the plurality of redundant sectors corresponding to the plurality of groups forming the first set of groups, and a plurality of redundant sectors corresponding to the plurality of groups forming the second set of groups.

13. The controller of claim 11, wherein the free area is located subsequent to a data sector position in which a data sector where user data is recorded last is located.

14. The controller of claim 11, wherein in accordance with a plurality of grouping rules different from each other and including a grouping rule for the grouping, the sequencer groups a plurality of data sectors arranged on the plurality of tracks, into respective pluralities of groups forming a plurality of sets of groups including the first set of groups, and arranges in the free area, respective pluralities of redundant sectors corresponding to the respective pluralities of groups.

15. The controller of claim 11, wherein:
the magnetic disk device further comprises a memory including a redundant data area for storing initial or intermediate data of redundant data corresponding to the plurality of groups; and
the sequencer generates new redundant data in accordance with arrangement, in the storage area, of a first data sector where first user data is recorded, based on first redundant data and the first user data, and updates the first redundant data to the generated redundant data, the first redundant data corresponding to a group to which the first data sector belongs, and being stored in the redundant data area.

16. The disk controller of claim 11, wherein in the grouping, the sequencer shifts positions of the plurality of groups for each track a given number of data sectors by a given number of data sectors.

17. A redundancy sector arrangement method in a magnetic disk device including a disk comprising a storage area including a plurality of tracks, the redundancy sector arrangement method comprising:
grouping, data sector by data sector into a plurality of groups forming a first set of groups, a plurality of data sectors arranged on each of the plurality of tracks, such that those of the plurality of groups that are arranged at least adjacent to each other differ in position from each other; and
arranging a plurality of redundant sectors corresponding to the plurality of groups in a free area in the storage area.

18. The method of claim 17, further comprising:
in accordance with a grouping rule different from a grouping rule used for the grouping, grouping a plurality of data sectors arranged on the plurality of tracks, into a plurality of groups forming a second set of groups; and
arranging in the free area, the plurality of redundant sectors corresponding to the plurality of groups forming the first set of groups, and a plurality of redundant sectors corresponding to the plurality of groups forming the second set of groups.

19. The method of claim 17, wherein the free area is located subsequent to a data sector position in which a data sector where user data is recorded last is located.

20. The method of claim 17, wherein:
the magnetic disk device further comprises a memory including a redundant data area for storing initial or intermediate data of redundant data corresponding to the plurality of groups; and
the method further comprises
generating new redundant data in accordance with arrangement, in the storage area, of a first data sector where first user data is recorded, based on first redundant data and the first user data, the first redundant data corresponding to a group to which the first data sector belongs, and being stored in the redundant data area; and
updating the first redundant data to the generated redundant data.
